(19) United States
(12) Patent Application Publication
(10) Pub. No.: US 2003/0101331 A1
(43) Pub. Date: May 29, 2003

(54) ASIC design technique

(76) Inventors: Sean T. Boylan, Galway (IE); Vincent G. Gavin, Galway (IE); Kevin Jennings, Ballinasloe (IE); Mike Lardner, Tuam (IE); Tadhg Creedon, Furbo (IE); Brendan G. Boesen, Galway (IE)

Correspondence Address: NIXON & VANDERHYE P.C., 8th Floor, 1100 North Glebe Rd., Arlington, VA, 22201-4714, US

(21) Appl. No.: 10/002,980

(22) Filed: Dec. 6, 2001

(30) Foreign Application Priority Data
Oct. 6, 2001 (GB) 0124093.6

(51) Int. Cl. G06F 15/00

(52) U.S. Cl. 712/36

(57) ABSTRACT

A view-based design technique for an ASIC includes selecting a particular multiple level hierarchy and for each level in the hierarchy creating a hardware description language file which declares the relevant signals and module instantiations.

### FIELD OF THE INVENTION

The present invention relates to the design of application specific integrated circuits. More particularly it relates to a design technique which is intended to be particularly suitable for application specific integrated circuits (ASICs) which are mainly composed of a selectable multiplicity of functional blocks or ‘cores’ and the circuit is designed to conform to various architectural rules which prescribe the manner in which signals pass between the cores by way of memory buses, for data signals, register buses, for signals employed to read or write from control or status registers in cores, and control buses, for signals such as interrupts for processors. Thus it is particularly relevant to ‘system on a chip’ design wherein a plurality of distinct hardware cores are integrated together in order to create a much larger design. The invention is generally applicable to ASIC design employing a hardware description language (HDL).

### BACKGROUND OF THE INVENTION

It is now commonplace to employ what is known as ‘top-down design’ otherwise termed functional decomposition, for the design of application specific integrated circuits. In this process, the ASIC is decomposed into several top level functions. Each block has its signal interfaces defined and its functions clearly stated. This top-down technique is applied recursively down through the design, breaking up each new top-level module into a set of sub-modules until the function of the sub-module is such that it can be readily described in terms of hardware and designed as a single state machine or equivalent.

During the decomposition, modules are partitioned by function. It is much easier to design a module with a unified function rather than as a group of miscellaneous functions. Top-down design is complete once the sub-modules do not logically divide down any further, they implement a well defined function or set of functions and are of a manageable design size.

In an ASIC design described by a hardware description language (HDL), such as Verilog and VHDL, the functionality of a module is defined by a combination of structural connections between blocks (module instances) and algorithmic logic. At higher levels of functionality, the design consists of structural, rather than algorithmic, HDL.

Development activity focuses on the lowest level sub-modules as defined by the top-down design process. These modules, known hereafter as cores, are functionally non-trivial and usually consist of a mixture of structural and algorithmic Verilog. Typically they are the subject of separate, individual design and may be held in a ‘library’ to which the ASIC designer has access. The intermediate modules that were defined during top-down design contain only hierarchical or structural HDL. The hierarchical HDL describes the interconnections between cores and at the top level the chip's input and output pins. It does not contain any algorithmic logic.

The structural HDL describing the design hierarchy is usually generated by hand. Any changes to the core interfaces or to the hierarchy are therefore time-consuming, onerous and prone to error. At any level within the hierarchy it is likely that the designer will have to deal with large numbers (tens or even hundreds) of signals. The advent of large SoC designs made up of many millions of gates and continuously shrinking IC geometries means that the size of the hierarchical HDL will continue to increase. It is a difficult task to ensure that the connections between the cores are correctly maintained. It is difficult to maintain a consistent signal naming convention as signals descend and ascend through the hierarchy. This is made even more difficult if many different designers are (as is commonplace) working on creating or modifying the hierarchical HDL. An inconsistent naming convention can result in confusion and lost time during system-level simulation and debugging.

### SUMMARY OF THE INVENTION

The present invention concerns a view-based technique which facilitates the creation of a self-consistent description of a complex design in a hardware description language. The technique allows a multiplicity of different hierarchical views to suit different aspects of the design which is to be created. Typical views include a layout view, a subsystem simulation view, a view to match EDA tool requirements and a functional decomposition view. The HDL hierarchy of each of these views can be optimised to best meet the requirements of the particular task under-completion. The number of levels in the HDL hierarchy can be radically different depending on the task. The starting point for the creation of the new hierarchical views would be an existing hierarchy defined using top-down design techniques.

Formal verification techniques allow engineers to compare different netlists to prove that they are functionally equivalent. A netlist is converted into mathematical models that represent the HDL descriptions. When formal verification techniques are applied to different HDL hierarchies with the same cores and the same interface connections then they will be proved to be functionally equivalent.

The nature of the invention and further features of it will be made clear in the following description with reference to the accompanying drawings.

### BRIEF DESCRIPTION OF THE DRAWINGS

FIG. 1 illustrates a plurality of cores, namely functional blocks, in a deliberately simplified application specific integrated circuit.

FIG. 2 is a diagram illustrating two different hierarchies.

FIG. 3 illustrates an ASIC and its connections to external devices.

FIG. 4 illustrates one example of a hierarchy employed using a top-down design approach.

FIG. 5 is a diagram illustrating a hierarchy based on clock domains.

FIG. 6 illustrates two different hierarchical groupings for the same set of modules in an ASIC.

FIG. 7 is a diagram illustrating the interconnection of cores by memory paths.

FIG. 8 is a diagram illustrating the interconnection of cores by register bus paths.

FIG. 9 is a diagram illustrating the interconnections of cores by control paths.

FIG. 10 is a UML model of connections representation of connections captured using a schematic entry tool.

FIG. 11 illustrates the sub-classification of ports.

FIG. 12 is a UML model of a hierarchy and connections.

### DETAILED DESCRIPTION

1. Background

Although the invention is intended to have more general utility, it is intended in one form to facilitate the design process of systems on a chip which are designed and organised according to the techniques described in the following co-pending applications, which are commonly assigned herewith, incorporated by reference herein, and briefly summarised below.

(a) Ser. No. 09/893,659 filed Jun. 29, 2001 for Creedon et al. describes an architecture in which the functional blocks or cores exchange data messages substantially only by way of memory, the cores being able to initiate memory transactions (reads and writes) on a memory bus system which includes aggregators that can arbitrate between memory transactions proceeding from different cores to the same common memory (which may be on-chip or off-chip) and which allows different data rates and bus widths on different sections of the memory bus system.

(b) Ser. No. 09/919,806 filed Aug. 2, 2001 for Boylan et al. describes the automatic generation in a hardware description language of the interconnects required according to the predetermined architecture. These interconnects include the memory bus system, a register bus system by means of which cores and particularly processors, can monitor or control registers within other cores, and control buses, for the conveyance of such signals as interrupts.

(c) Ser. No. 09/893,658 filed Jun. 29, 2001 for Hughes et al. describes a technique in which memory transactions include a source identification (source ID) and preferably also a transaction number. That technique is intended to avoid ‘freezing’ of paths to memory while a particularly transaction is being enacted and facilitates an orderly response to memory transactions despite variable latency in the memory bus system.

(d) Ser. No. 09/879,065 filed Jun. 13, 2001 for Pratt et al. describes a number-based ASIC clock system which constrains clocks derived from a system clock to have transitions at particular times. The purpose is partly to avoid the distribution of the system clock as such throughout all the ASIC, and thereby to avoid frequency shift owing to excessive loading of the system clock. It also facilitates in appropriate circumstances the avoidance of ‘elastic’ buffers for the transfer of signals between cores that may operate at different sub-multiples of the system clock.

Some Figures taken from the aforementioned co-pending applications are reproduced herein by way of example and explanation. However, the present invention is not intended to be limited specifically to the design techniques and architecture indicated in the aforementioned co-pending applications.

2. Simple Connections between HDL modules

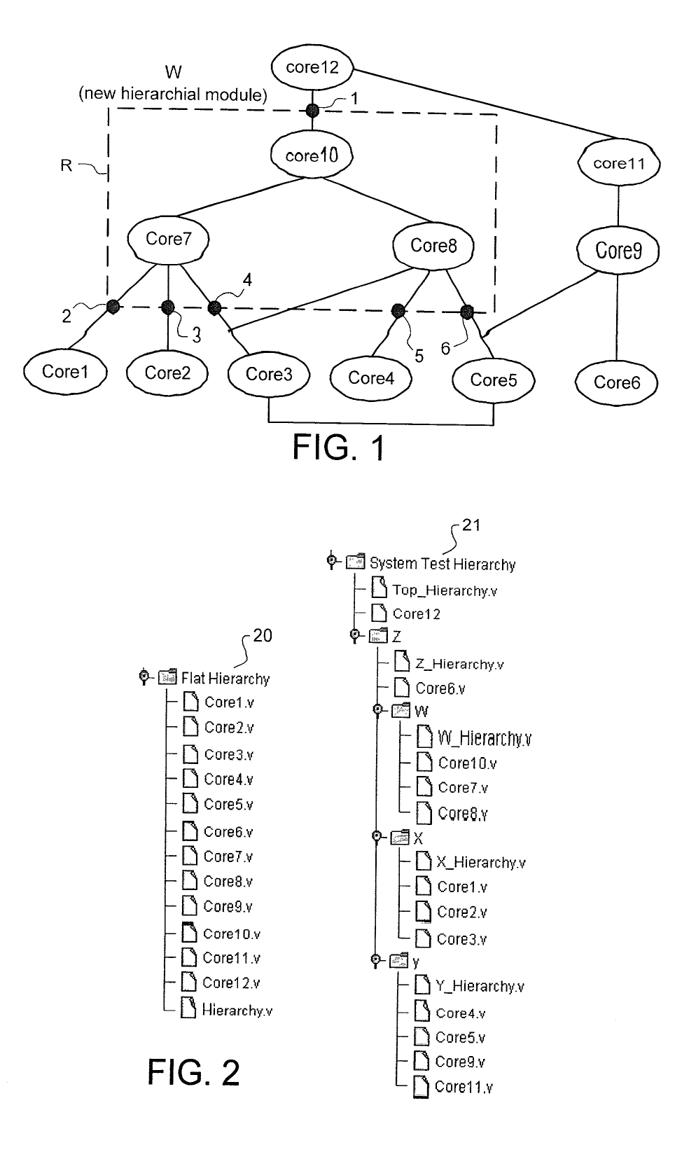

FIG. 1 shows by way of example the connections between a number of different cores denoted ‘core 1’ to ‘core 12’ in an ASIC. In practice the number of cores and the number of connections would be much larger in a real ASIC. The dashed rectangle R shows one of the levels of hierarchy (W) introduced into the design in FIG. 2. The dots 1 to 6 denote the connections (input and output signals) that constitutes this hierarchical module's interface. Each of the cores represents an HDL module that implements a well defined function.

3. Hierarchical Views

FIG. 2 shows two different hierarchies for the cores shown in FIG. 1, viz. a flat hierarchy 20 and a system test hierarchy 21 The flat hierarchy has one hierarchical HDL module called “Hierarchy.v” which contains the twelve core module instantiations and declarations for the connections between them. The system test hierarchy has five hierarchical HDL modules (Top_Hierarchy.v, Z_Hierarchy.v, W_Hierarchy.v, X_Hierarchy.v, Y_Hierarchy.v). The module instantiations for the twelve cores are dispersed among the five hierarchical HDL modules, as are the connections. For example the connection between core11 and core12 results in a signal ascending through the following levels in the hierarchy.

Y_Hierarchy→Z_Hierarchy→Top_Hierarchy

The connection between core3 and core10 results in a signal ascending and then descending through the following levels in the hierarchy.

X_Hierarchy→Z_Hierarchy→W_Hierarchy

Even though the HDL is different the two separate hierarchical views would be proved to be functionally equivalent if formal verification techniques were applied.

The ability to automatically generate different hierarchical views depending on the ASIC design task would be of significant benefit to the ASIC design flow. The benefits provided may be illustrated using a hypothetical design example.

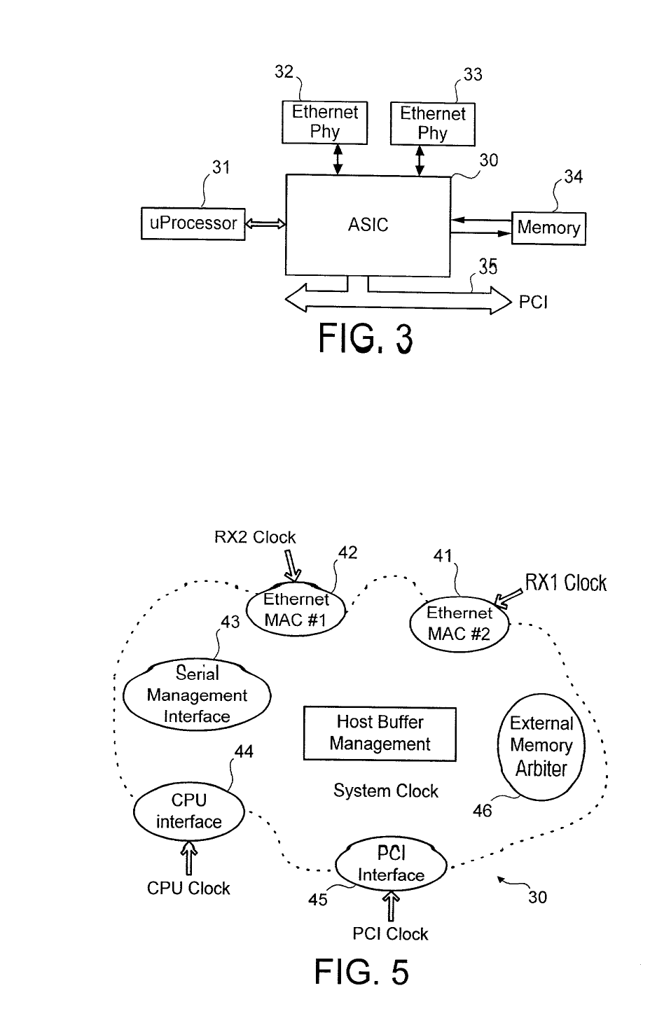

FIG. 3 illustrates by way of example an ASIC 30 which is required to have external interfaces to a microprocessor 31, two Ethernet physical layers 32, 33 (PHYs), an external memory 34 and a PCI bus 35. Broadly speaking, a schematic diagram such as shown in FIG. 3, but normally a more complex diagram, would be included within the ‘inputs’ or design requirements to a top-down design session.

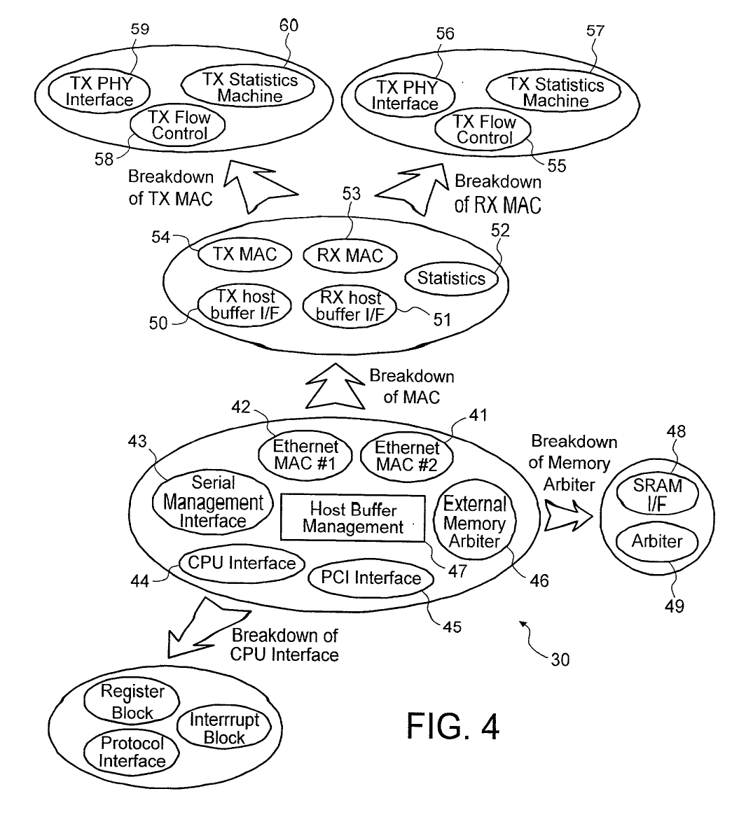

FIG. 4 illustrates a hierarchy that arises when employing a top-down design approach for the ASIC shown in FIG. 3. Very typically the ASIC includes internal operational blocks such as two Ethernet MACs 41 and 42, a serial management interface 43, a CPU interface 44, a PCI interface 45, a memory arbiter 46 and a host buffer management block 47. The CPU interface decomposes into an interrupt block, a register block and a protocol interface. The arbiter 46 for the external memory decomposes into an SRAM interface 48 and an arbiter block 49. Each media access control MAC may be decomposed into a TX (transmit) host buffer interface 50, a RX host buffer interface 51, a statistics block 52, an RX (receive) MAC 53 and a TX MAC 54. The RX MAC 53 further decomposes into a RX flow control block 55, an RX PHY interface 56 and an RX statistics machine 57. The TX MAC decomposes into a TX flow control block 58, a TX PHY interface 59 and a TX statistics machine 60. It is assumed in this description that the reader is familiar with the OSI Model. The term ‘MAC’ is intended to correspond to the data link layer in that model.

For convenience, the interconnect signals between the various operational blocks have been omitted from FIG. 4.

4. Grouping for Layout

The latest deep submicron technologies mean that routing delays between modules now normally dominate over actual individual gate delays when laying out SoC chips. In the case of the hypothetical design the following routing layout constraints and solutions might exist.

(a) The blocks “RX Phy Interface” 56 and “TX Phy Interface” 57 may have very tight timing constraints and would need to be placed very close to the Ethernet Phy pins.

Even though these files are buried two levels down in the original hierarchy they should be grouped at the top level in a layout hierarchy in order to identify to the layout tool that they need to be placed beside each other for layout purposes.

(b) The “SRAM Interface” 48 has tight timing constraints and must be placed near the I/O pins of the memory.

The “SRAM Interface” could be moved to the top level in the hierarchy and placed beside the memory pins for layout purposes. The “Arbiter” 49 may well not have any tight timing constraints with the “SRAM Interface” and so it could remain at its current level in the hierarchy but should be grouped close to the “Host Buffer Management Interface” 47.

One of the most difficult tasks for the project manager on a ASIC project is to estimate accurately the time it will take to layout a chip. Layout is an iterative process wherein the layout results are communicated back to the design team. The iterations will stop only when all timing issues have been resolved. This is often described as “timing closure”. An ability to modify the hierarchy easily within a netlist can greatly reduce the time needed to achieve closure.

5. Grouping according to Clock Frequency

When dealing with multiple clock domains on a chip the advice that is often given is to limit the number of different clock domains in the chip. Multiple clock domains can often complicate synthesis and scan chain testing. When multiple clock domains are used it is very likely that meta-stability problems will be encountered if special care is not taken for signals crossing clock boundaries. SoC type developments have multiple different IP Cores all running at different clock frequencies and it is almost impossible to avoid multiple clock domains.

One of the chief techniques currently employed is to isolate all signals crossing from one clock domain to another using special dedicated blocks. These blocks can be synthesised separately and have special attention given to them. The synthesis techniques for managing boundary crossing signals can be concentrated on these blocks.

A more adaptable approach is to group modules according to clock frequency. The hierarchy introduced by these groupings makes it obvious to designers where special techniques to manage signals crossing clock boundaries need to be applied. This approach has the advantage that there is no need for modules dedicated to clock domain crossing within the design. Likewise there is no need for exhaustive searches throughout the netlist to identify all the signals crossing clock domains; they are immediately obvious from the hierarchy.

FIG. 5 illustrates for the ASIC in FIG. 3 five clock domains that might exist in the hypothetical design. These domains are represented by the CPU clock, the PCI clock, a system clock, an Ethernet RX1 clock and an Ethernet RX2 clock.

It is clear from FIG. 5 that the CPU interface is split across two clock boundaries, i.e. the system clock and the CPU clock. For example, the interface may include a register block which runs at CPU clock, a CPU Protocol block which also runs at CPU clock and an interrupt controller which runs at the System Clock

The hierarchical groupings and hence the HDL would be modified so that the Register block and CPU Protocol block would be contained in their own level of hierarchy. The interrupt controller would be moved into a level of hierarchy containing all the modules running at the System clock frequency.

Grouping according to clock frequency can also help in the layout stage because each clock domain may be restrained in area to limit the difficulty in balancing a clock tree by wiring and to avoid unnecessary interconnect delays on the clocks.

6. Grouping for Subsystem Simulation

Verification of an ASIC consumes at present generally about 70 % of ASIC development effort. The consequences of an inadequate verification process can range from a non-functional design requiring several expensive revisions, a design with only a subset of the desired functionality or a delayed product shipment.

One of the main elements of current verification processes is subsystem simulation. The goal of subsystem simulation is to run tests on a number of modules that combine together logically to form a single higher level function and that are more efficiently tested as a combined unit, instead of as individual modules. Subsystem simulation enables simulation to start earlier in a project; it requires less code than chip simulation and hence runs more quickly. Furthermore it allows a bottom-up verification process, testing the lower levels first and then building on from there by including other new interconnect blocks or subsystems. Modules are difficult to test at chip level where inputs to the modules are difficult to control.

For these reasons it is very important that a hierarchy that matches the requirements of subsystem simulation can be easily created. In the hypothetical design example under discussion there would be three different subsystem simulations that the design team might wish to run, as shown in Table 1:

TABLE 1

| Subsystem | Required Blocks |
|---|---|
| MAC test | MAC #1, Host buffer management, |
| | External memory arbiter, Register block |
| PCI test | PCI interface, Host buffer management, |
| | External memory arbiter, Register block |
| CPU test | PCI interface, Host buffer management, |
| | External memory arbiter, Register block, |
| | Serial Management interface |

The facility to create a new HDL hierarchy to match the needs of a particular subsystem simulation has many advantages. When building the subsystem simulation environment it is much easier to disable unused functionality. Such unused interfaces would be exposed at the top level of the new hierarchy and can therefore be easily ‘tied off’. New subsystem simulation environments do not need to be created by hand. There is no time lost debugging the manually-created subsystem environment and removing errors in the new hierarchy. The verification effort can immediately be concentrated on finding and removing real functional errors. The fact that the HDL hierarchies are automatically created allows all the various designers to run simulation from the same functional base.

The automatic generation of the subsystem simulation hierarchies greatly facilitates the replacement of a core module with any of the following:

(i) a Structural RTL, represented by actual physical gate structures (Flops, NAND, Nor gates etc).

(ii) a C module, i.e. a ‘C’ model performing the functions of the core.

(iii) a Transactor, i.e. a higher level behavioural model of the block, sometimes using structures that cannot be synthesised. A transactor may be written in HDL or some other higher level language.

(iv) a Verilog RTL model, i.e. the HDL code used to capture the design, being the code that is synthesised to produce the structural RTL.

(v) an ‘empty’ module, declaring the necessary input/output pins but not containing any logic (and therefore not consuming simulation time).

Thus one may create a hierarchical view with different representations of the core modules. This might be necessary because at the particular phase of the project, design of all the modules might not have been completed. The full source code for a particular block might not be available or might take too long to simulate (E.g. CPU block).

In the hypothetical design example the following might be desirable:

(i) replacement of the complete RX MAC with a transactor;

(ii) replacement of the CPU Protocol interface with a ‘C’ model.

7. Grouping to match EDA tool requirements

There is a large selection of Electronic Design Automation (EDA) tools available for use throughout ASIC design. Some of these tools place special requirements on the RTL that can affect the HDL hierarchy. Many of the tools used by ASIC vendors require hard core placement of specific hard macro types such as CPU blocks, FIFOs, SILOs, PLL's, delay cells, register blocks. A particular vendor's tool set might require that a subset of these hard macros be placed at the top level of the hierarchy. If a design is transferred from one vendor to another the blocks required at the top level may change. This could require large modifications to the netlist and therefore introduce a considerable risk factor into the design.

For very large ASIC's a sub-chip design approach is often taken in order to meet the requirements of floor planning and layout tools. The concept behind sub-chip design involves carefully defining the boundary between the notional chips. Because the sub-chips are smaller it is much easier for them to individually meet the layout and floor planning constraints. The interface between the sub-chips is optimised in order to meet timing constraints. The ability to explore different HDL hierarchies would allow this interface to be rapidly defined.

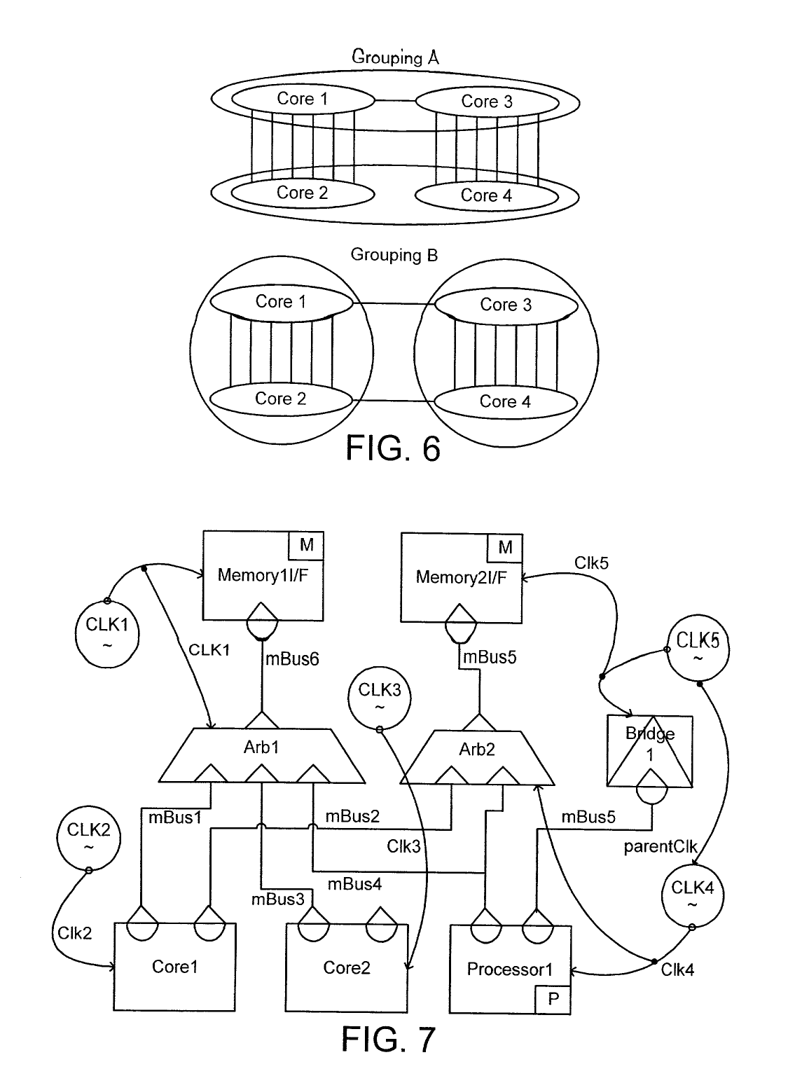

FIG. 6 shows by way of example two different hierarchical groupings A and B for a set of four modules core 1 to core 4. In grouping A core 1 and core 3 are grouped together, as are core 2 and core 4. In grouping B core I and core 2 are grouped together as are core 3 and core 4. It is obvious that grouping B has many fewer interface signals between groups than does grouping B.

8. Hierarchical HDL

Only a specific subset of the HDL language should be used in the hierarchical HDL (e.g. verilog) in order to ensure that the hierarchy can be modified to suit the different aspects of ASIC design described previously. This subset would consist only of those languauge elements required to define modules and to connect module instances. The Register Transfer Level (RTL) subset of both Verilog and VHDL is the subset of the language that should be used in creating a design that can be synthesised into actual physical gates; therefore hardware engineers are well used to using a subset of the language.

The following defines the subset of HDL that should be used. For the purposes of explanation all examples have been given in Verilog but a similar subset can be defined for other HDL languages such as VHDL.

| | |
|---|---|
| Interface Declaration | Define the interface of this hierarchical module |

module myHierarchy (

clk,
wrAckReq,
HRDATA,
HREADY);

. . .
endModule

| | |
|---|---|
| Input Signals | Declare all input signals |

input [5:0] signal1;
wire [5:0] signal1;

| | |
|---|---|
| Output Signals | Declare all output signals |

output [5:0] signal2;
wire [5:0] signal2;

| | |
|---|---|
| Local Signals | These are used to define any local connections between two or more module |
| | instantiations at this level in the HDL hierarchy |

wire localSignal;

| | |
|---|---|
| Module Instantiations | This is used to create another level of hierarchy below the current level or else to |
| | create an instance of a core (algorithmic) module |

moduleFoo myFoo (

.reset (hReset),

.burstStartEn (1 ′ b1),

.clk (clk),

.rdAdd (rdAdd [31:0] ) );

9. Generation of HDL Hierarchy

There now follows a top-level description of a possible scheme that could be used to implement a tool to automate the generation of different hierarchies. The main steps involved in creating a new hierarchical view are as follows:

(i) Describe the connections (graphically or otherwise) between the cores and model these connections in software;

(ii) Describe the selected hierarchy (graphically or otherwise) and model this hierarchy in software;

(iii) For each level in the hierarchy create a hierarchical verilog file and declare all necessary input/output signals, all local signals and module instantiations.

These steps are more particularly described below.

10. Describe Connections

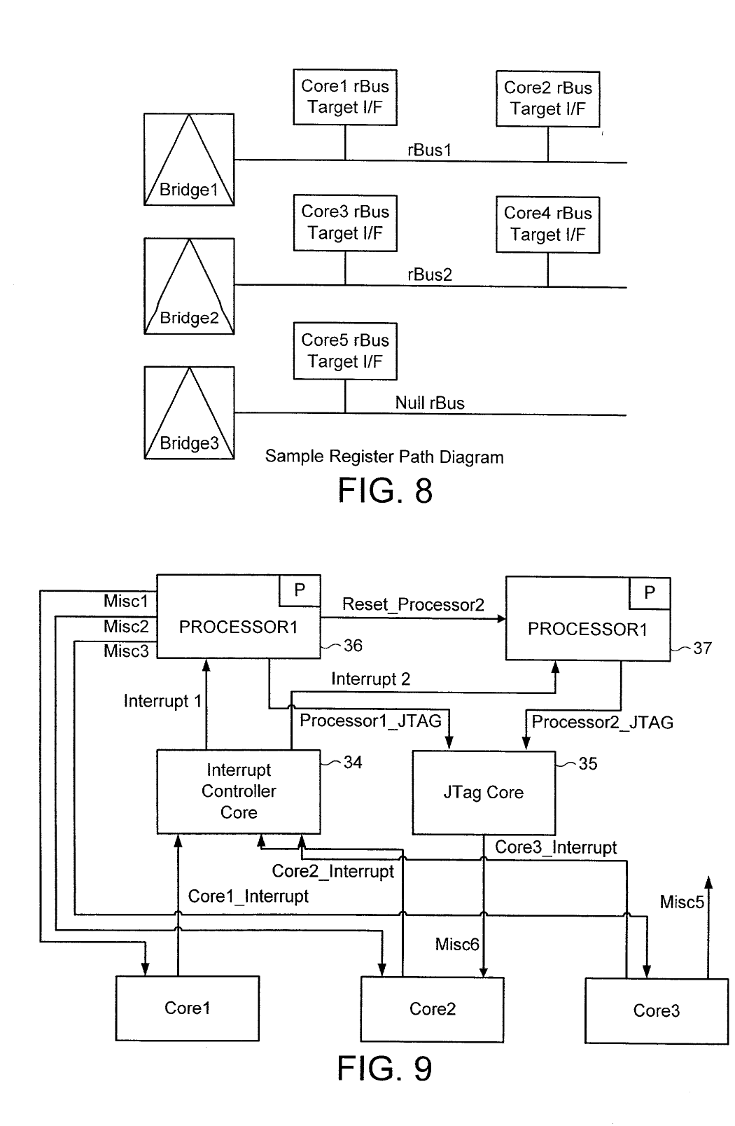

This could be achieved using a spreadsheet or as preferred a graphical picture showing the cores/modules and how they are connected together. FIG. 7, FIG. 8 and FIG. 9, which correspond to FIGS. 1 to 3 of the aforementioned application No. 0118840.8, show various cores and, respectively, memory bus connections, register bus connections and control bus connections. As the connections are specified using the schematic entry tool a software model describing the connections will be created.

FIG. 10 represents a possible Unified Modelling Language (UML) representation of the connections captured using a schematic entry tool.

The class ‘Module Instance’ models a HDL module instantiation and its main attribute is the instantiation name of the module. It contains one or more ports which model the module's interface.

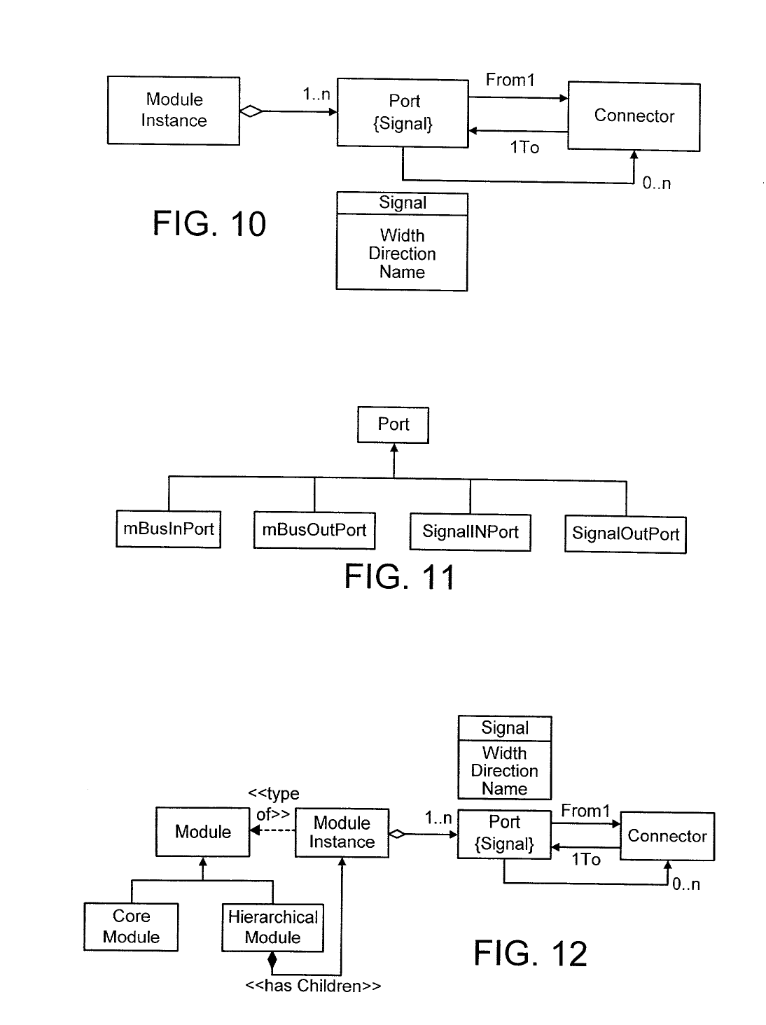

A ‘port’ is used to represent the HDL input and output signals from the module. A port may represent either an individual HDL signal or a collection of signals. A port that contains a collection of signals models a bus such as the mBus and rbus described in the aforementioned applications or some other bus specification. It might be desirable to restrict the types of ports that can be connected together and also how ports can be connected. This would be achieved by sub-classing ports as shown in FIG. 11.

The model in FIG. 10 shows that a ‘connector’ is used to connect two ports. The normal rules of schematic entry would apply to the type of connections that could be made. A port may have zero or more connectors attached to it. This represents the fact that in HDL, signals can be either left floating or connected to multiple destinations

A ‘port’ supports multiple ‘connectors’ because a bus such as the mBus can be multicast to multiple destinations. Also an individual signal which is N bits wide can be split so that the discrete segments of bits can be connected to different destinations.

A special type of port or connector would be provided to represent the case where the signal/signals on a port are being tied off. The connector is responsible for ensuring that the signal naming connection used to map signals to each other as they ascend and descend through the HDL hierarchy is consistent.

The signal class represents a HDL signal which has three main properties: width, direction and name.

11. Describe Hierarchy

Before any hierarchical HDL can be generated, the HDL hierarchy needs to be described. Again, this can be achieved using a spreadsheet or, as preferred, a graphical picture to describe the hierarchy, similiar to that shown previously in FIG. 2. As the user moves modules from folder to folder to create the desired hierarchy the software model representing it would be modified to reflect the current hierarchy.

FIG. 12 is an UML diagram which describes how the hierarchy would be represented. Each time the hierarchy is modified a copy of the current hierarchy is made. The model is then modified to reflect the changes to the hierarchy that have been made graphically. This involves cycling through the tree of hierarchical modules to do the following:

(a) Deletion of hierarchical modules that no longer exist.

(b) Creation of new hierarchical modules and insertion of them into the hierarchy tree.

(c) Creation of the ports and connectors that constitute the new Module Instances.

(d) Modification of the set of module instances maintained by a hierarchical module.

12. Generate Hierarchical HDL

Once the user is satisfied with a hierarchy that meets the requirements of 30 the design task (as described earlier) the HDL can be generated. The following pseudo-code describes the steps involved:

ROOT_MODULE = an object that
represents the top-level module in
the hierarchy.
HDL_WRITER = an object that outputs
HDL (verilog/VHDL) to file using the
correct syntax.

generaterHDLForChildren (ROOT_MODULE,
HDL_WRITER) ;
generateHDLForChildren ( module ,
HDLWriter ) {

module.getChildren ( ) .iterate (

if ( child.isInstanceOf (

“Hierarchical Module ” ) )

generateHDLForChildren (

child , HDLWriter )

) ;
generateHierarchicalHDL ( module ,

HDLWriter ) ;
}
generateHierarchicalHDL ( module ,
HDLWriter ) {

thisModuleInstance =
module.asInstance ( ) ;
startModuleDeclaration (module) ;
thisModuleInstance.getPorts. ( ) .iterat

e ( ) {

port.getSignals ( ) .iterate (

HDLWriter.addSignalToModuleDeclaratio

n (signal) ;

) ;

}
HDLWriter.declareModule ( ) ;
moudle.getChildren ( ) .iterate ( ) {

child.getPorts ( ) .iterate ( ) {

port.getConnector ( ) .iterate ( )

{ )

if (connector.isConnectedTo (

thisModuleInstance) == FALSE) {
HDLWriter.declareLocalSignals (port.getSi
gnals ( ) , connector) ;

}

}

}

}
module.getChildren ( ) .iterate ( ) {

startModuleInstantiation (child) ;
child.getPorts ( ) .iterate ( ) {

port.getSignals ( ) .iterate ( )
{
HDLWriter.addSignalsToModul
eInstantiation (signal,
port.getConncectors ( ) ) ;

}

}

HDLWriter.declareModuleInstantiation (

) ;

}
HDLWriter.endModuleDeclaration ( ) ;

}

The following is a description of the functionality provided by each of the methods in the HDL writer class. The HDL writer class could implement the state pattern to ensure that the HDL is output in the correct order.

startModuleDeclaration(Module)

This method tells the HDL writer that a new Hierarchical module is being created. It will create the output file the HDL will be written to and start the declaration of the module using the module's name.

addSignalToModuleDeclaration(Signal)

Adds this signal to the set of signals that make up the module's interface.

declareModule( )

This method outputs all the signals that make up the module's interface from the set of signals created using the addSignalToModuleDeclaration. It creates the HDL declaration of each of the input and output signals. It knows how to query the signal class in order to extract the necessary information.

declareLocalSignals({Signal}, Connector)

This method takes a set of one or more signals and the connector associated with them. The method knows how to construct a local signal name based on the attributes of the Signal and connector objects. It will declare a local signal for each of the signals in the set.

startModuleInstantiation(Moduleinstance)

This method is used to start the instantiation of a module. It is able to extract the instance and module name needed for the instantiation.

addSignalsToModuleInstantiation(Signal, {connectors})

Add this signal to the list of signals that make up the module instantiation. The method knows how to output the mapping between the internal signal name of the module that is being instantiated and the wire(s) that it is being connected to. The method also handles floating and tied off signals.

declareModuleInstantiation( )

This method outputs the HDL needed to instantiate a module.

endModuleDeclaration( )

This method tells the HDL writer that the HDL for the hierarchical module is complete and that the output file can be closed.

1. A method of generating a description in a hardware description language of an application specific integrated circuit composed of functional cores and interconnections for signals therebetween, comprising the steps of:
(i) describing said connections and modelling them in software;
(ii) describing a selected multiple-level hierarchy of the cores and modelling the selected hierarchy in software; and
(iii) for each level in the selected multiple-level hierarchy, creating a hardware description language file which declares the signals and relevant module instantiations.

2. A method according to claim 1 wherein said step (i) comprises forming a graphical picture of said functional cores and interconnections and creating a software model thereof using a schematic entry tool.

3. A method according to claim 2 wherein said software model includes instances of modules and ports that represent input and output signals for each module.

4. A method according to claim 1 wherein said step (ii) comprises producing a graphical picture of the ASIC in terms of the selected hierarchy.

5. A method according to claim 1 wherein the selected hierarchy is a system test hierarchy.

6. A method according to claim 1 wherein the selected hierarchy is based on physical grouping of cores.

7. A method according to claim 1 wherein the selected hierarchy is based on clock domains.

8. A method according to claim 1 wherein the selected hierarchy is based on a grouping for subsystem simulators.

9. A method according to claim 1 wherein the selected hierarchy is based on the requirements of an automatic placement tool.

10. A method of generating a description in a hardware description language of an application specific integrated circuit composed of functional cores and interconnections for signals therebetween, comprising the steps of:
(a) describing said connections by forming a graphical picture of said functional cores and interconnections;
(b) using a schematic entry tool to create a software model of said functional cores and interconnections;
(c) describing a selected multiple-level hierarchy of the cores in graphical form and modelling the selected hierarchy in software; and
(d) for each level in the selected multiple-level hierarchy, creating a hardware description language file which declares the signals and relevant module instantiations.

11. A method according to claim 10 wherein said software model includes instances of modules and ports that represent input and output signals for each module.

12. A method according to claim 10 wherein the selected hierarchy is a system test hierarchy.

13. A method according to claim 10 wherein the selected hierarchy is based on physical grouping of cores.

14. A method according to claim 10 wherein the selected hierarchy is based on clock domains.

15. A method according to claim 10 wherein the selected hierarchy is based on a grouping for subsystem simulators.

16. A method according to claim 10 wherein the selected hierarchy is based on the requirements of an automatic placement tool.
